(19) United States
(12) Patent Application Publication
(10) Pub. No.: US 2018/0050303 A1
(43) Pub. Date: Feb. 22, 2018

(54) TREATMENT OF EXHAUST GASES FROM CEMENT CLINKER PRODUCTION

(71) Applicant: HEIDELBERGCEMENT AG, Heidelberg (DE)

(72) Inventor: Stefan FEDERHEN, Hirschberg (DE)

(73) Assignee: HEIDELBERGCEMENT AG, Heidelberg (DE)

(21) Appl. No.: 15/557,882

(22) PCT Filed: Apr. 8, 2016
(86) PCT No.: PCT/EP2016/000585

§ 371 Date: Sep. 13, 2017

(30) Foreign Application Priority Data
Apr. 24, 2015 (EP) 15001227.6

(51) Int. Cl. B01D 53/56; B01D 53/86; C04B 7/36

(52) U.S. Cl. CPC B01D 53/56; B01D 53/8634; B01D 2258/0233; B01D 2255/20723; B01D 2255/20738; C04B 7/364

(57) ABSTRACT

Method for the purification of exhaust gas from the production of cement clinker in a rotary kiln, in which raw materials are ground in a mill to form raw meal, raw meal is preheated in countercurrent in a preheater with exhaust gas from the rotary kiln and optionally precalcined, preheated and optionally precalcined raw meal is supplied to the rotary kiln and burned in the rotary kiln to form cement, the exhaust gas from the rotary kiln is denitrified before entering the preheater of a selective non-catalytic nitrogen oxide reduction with a reagent which provides ammonia, and wherein, according to the invention, the exhaust gas from the preheater is subjected to gas conditioning and catalytic oxidation of ammonia. The object is further solved by means of a device for gas conditioning and catalytic oxidation which is arranged between the preheater and the mill.

The present invention relates to a method and a device for the treatment of exhaust gases which arise during the production of cement clinker in a rotary kiln.

Cement production by burning raw meal to form clinker requires high temperatures at which the formation of various pollutants, especially of nitrogen oxides, cannot be prevented. In view of the increasingly lower limit values for the emission of pollutants, a variety of methods have been developed to remove them from the exhaust gas. The following proposals show the prior art, particularly with respect to denitrification.

A first approach consists in the conversion of the nitrogen oxides, NO and NO₂, collectively referred to as NOₓ, with ammonia or urea solution, typically at 900 to 1000° C. This method is referred to as selective non-catalytic reduction, or SNCR for short. An example of this is WO 201 2/1 761 6 A1 which describes a method in which ammonia or a compound releasing ammonia, such as urea, is supplied as the reagent to raw meal preheating. In order to improve mixing, exhaust gas is removed from preheating, freed from dust, and then the reagent is added to it. The dedusted gas which is charged with reagent is then returned to the preheater.

More effective denitrification can be achieved with the aid of selective catalytic reduction, SCR for short. Ammonia, optionally produced in situ from compounds releasing it, is also used as the reagent. The reaction is carried out on catalysts which mainly consist of titanium dioxide and are doped with vanadium pentoxide and tungsten trioxide. One example is CN 102698600 A, according to which the exhaust gas from raw meal preheating is at least partially passed through a corresponding catalyst. DE 10 2011 001 773 A1 proposes to also supply the exhaust gases from a predrying of alternative fuels to the same catalyst, such that carbonaceous odorous substances and ammonia contained therein are also reacted on the catalyst.

The fact that an excess of ammonia is necessary for a substantial degree of reaction of the nitrogen oxides is a problem in the SNCR and the SCR. In general, the lower the emission limit value, the higher the excess must be. However, excessively high excess leads to the unreacted ammonia being contained in the exhaust gas after the reduction reaction, so-called ammonia slip, which is only permitted to a limited extent. In order to solve the problem, it is proposed in U.S. Pat. No. 5,510,092 A to purify the exhaust gas substantially by means of SCR and to additionally introduce ammonia in an SNCR zone only when an excessively high NOₓ concentration in the exhaust gas is detected. This is to ensure safe compliance with very low nitrogen oxide contents in the exhaust gas, without a large excess of ammonia being necessary and being able to enter the exhaust gas.

A further proposal for exhaust gas purification can be found in DE 10 2011 001 933 A1. The use of SCR in the exhaust gas of raw meal preheating is recommended for denitrification. In addition, exhaust gas from the raw material mill, in which the raw materials are ground into raw meal, is to be treated with alkali hydrogen carbonate and/or alkali carbonate in order to remove acidic pollutants such as sulphur oxides, hydrogen chloride and hydrogen fluoride. Thereby a reduction of the mercury content should also be achieved.

US 2009/0252665 A1 describes a combination of catalytic or non-catalytic reduction of the nitrogen oxides with a subsequent catalytic decomposition of excess ammonia for the purification of exhaust gas from steam boilers, heating units, kilns and other devices generating exhaust gas. There are no indications as to how this method could be used in cement production.

However, further requirements arise in cement production in addition to denitrification. The exhaust gas from preheating is generally guided into the raw material mill; first dust removal takes place in the exhaust gas flow from the mill at a filter upstream of the exhaust gas outlet. In order to protect the mill and this main exhaust gas filter, the exhaust gas must be de-acidified depending on the composition of the raw materials and the fuel material, which usually takes place during gas purification by supplying calcium hydroxide. Sulphur oxides and other acid gases are thus effectively removed from the exhaust gas. If acidic exhaust gases are allowed to enter the main filter, extensive corrosion may result, in particular in the clean gas area.

A further, specific problem is that, during preheating of the raw meal in the heat exchanger, ammonia contained in the raw material is also released. As a rule, ammonia from the SNCR and ammonia related to the raw material are adsorbed to the raw meal in the raw material mill. Ammonia is then accumulated in the system between the preheater and raw material mill and raw meal silo. The raw material mill is operated on average only about 85% of the time the rotary kiln works. During the time period in which the mill is not operated, so-called direct operation, the exhaust gas from the preheater directly enters the main filter. As a result, ammonia is increasingly drawn into the exhaust gas, since this is no longer adsorbed on the raw meal in the mill. During the period of direct operation, the previously deposited and accumulated ammonia is additionally released and temporally limited but high ammonia emissions result. The percentage of direct operation can be up to 30% or even just 5% of the kiln operating time in individual cases.

The object of purifying exhaust gases from cement production, in which the increasingly lower limit values can be fulfilled and the costs and the energy requirements remain acceptable, is therefore still not completely solved.

Surprisingly, it has now been found that very efficient exhaust gas purification can be achieved in cement production by carrying out denitrification by means of SNCR with a sufficiently high excess of reagent and subjecting the exhaust gases from preheating to a combined gas conditioning and catalytic oxidation.

The above object is therefore solved by a method for the purification of exhaust gas from the production of cement in a rotary kiln, in which raw materials are ground in a mill to form raw meal, raw meal is preheated in countercurrent in a preheater with exhaust gas from the rotary kiln and optionally precalcined, preheated and optionally precalcined raw meal is supplied to the rotary kiln and burned in the rotary kiln to form cement clinker, the exhaust gas from the rotary kiln is denitrified before entry into the preheater of a selective non-catalytic reduction with a reagent which provides ammonia and wherein, according to the invention, the exhaust gas from the preheater is subjected to gas conditioning and catalytic oxidation. The object is further solved by a device for gas conditioning and catalytic oxidation which is arranged between mill and preheater according to the invention in a plant for the production of cement clinker, comprising a mill, in which raw materials are ground to form raw meal, a preheater, in which the raw meal is preheated in countercurrent with exhaust gas from a rotary kiln and optionally precalcined, the rotary kiln, in which the preheated and optionally precalcined raw meal is burned to form cement clinker, and a section between the rotary kiln and preheater, in which nitrogen oxides are reduced with a reagent which provides ammonia. Gas conditioning can advantageously comprise gas purification with alkaline substances, preferably calcium hydroxide.

The plant for cement production largely corresponds to the known plants, therefore the known parts are not described in detail here. A detailed description can be found, for example, in W. H. Duda; Internationale Verfahrenstechniken der Zement Industrie, Volumes 1 to 3, 1985, Bauverlag Wiesbaden and Berlin.

According to the invention, a known SNCR is provided on the one hand. This is placed between the rotary kiln and preheater to comply with the desired reaction temperature of 830° C. to 970° C. By means of the SNCR, nitrogen oxides which have been formed in the rotary kiln or during the combustion of fuels or which originate from the raw material are reduced to nitrogen by adding ammonia or a compound which releases ammonia as a reagent. Ammonia or urea is preferably used as a reagent, in particular as an aqueous solution. The ratio of reagent to nitrogen oxides and the feed point are selected in such a way that the nitrogen oxides are reacted as completely as possible. For example, molar ratios for reagent, calculated as ammonia to nitrogen oxides (NH₃: NOₓ) of 1.1 to 2.5, preferably 1.3 to 1.6, are suitable. According to the invention, less consideration has to be given to a possible ammonia slip than in the prior art. This makes it possible to achieve an extensive conversion without the need for an SCR catalyst, which limits plant costs. Nitrogen oxide contents in the exhaust gas of <200 mg/m³ and even 150 mg/m³ are regularly achieved.

The SNCR takes place at a location in the plant where the exhaust gases are at a suitable temperature, for example from 800 to 1000° C., preferably from 830 to 950° C. As a result, no additional energy is required for the SNCR and the amount of ammonia, which would otherwise be ineffective for reduction and possibly burns itself to form NOₓ, is kept low.

According to the invention, selective catalytic oxidation (SCO) and gas conditioning (GK) take place between the preheater and the mill in addition. For direct operation, the branch for the bypass of the mill is located after the gas conditioning with catalytic oxidation such that only exhaust gas which has been treated according to the invention with both SNCR and with SCO and GK is supplied to the main exhaust gas filter.

Catalytic oxidation serves to oxidise ammonia related to the SNCR and the raw material in the exhaust gas to form nitrogen. Suitable catalysts are known to the person skilled in the art; they are used, for example, in exhaust gas treatment in fertiliser production. The catalysts used for the SCRs based on titanium dioxide catalyst carriers doped with vanadium pentoxide or tungsten trioxide can also be used, but it is preferred to increase the activity by adding precious metals such as palladium, rhodium and platinum, as well as copper or magnesium. The optimum temperature of the exhaust gases during oxidation is in the range from 275 to 380° C.

The catalysts advantageously also oxidise further existing pollutants. Therefore, mercury, which is difficult to remove from the exhaust gas in the elementary form, is oxidised and can thus be separated more effectively in the main filter. Sulphur dioxide is oxidised to form sulphur trioxide, which can be bound much more easily than SO₂ by means of dry sorption or semi-dry sorption. As mentioned above, the purifying effect with regard to sulphur oxides can be further optimised by means of gas purification with alkaline substances. Furthermore, volatile medium to long-chain hydrocarbons, so-called volatile organic compounds (VOC), are oxidised to form H₂O and CO₂.

Gas conditioning of the exhaust gas is primarily required to adjust the temperature and gas humidity of the exhaust gas to the respective optimum range for downstream dust separation devices such as, for example, bag filters or electric separators. This can have a positive influence on the dust and gas properties and thus reduce the installation and operating costs of dust removers.

According to the invention, catalytic oxidation and gas conditioning are carried out on an exhaust gas containing dust. In the prior art, previous partial dust removal is deemed necessary for a successful SCR. This is not necessary according to the invention. However, it is preferred to blow the catalyst clear with compressed air from time to time. For this purpose, a rotating unit with offset nozzles varying in cross section is preferably used. The pressure can be down to 0.8 bar at high compressed air flow rates, and up to 6 bar, maximum 8 bar at low compressed air flow rates. The rotating unit can be driven by the compressed air, or mechanically by a bevel gear drive. The bearing is expediently made of ceramic material, preferably of silicon carbide, and air purged. A hard metal bearing is also possible. In any case, the bearing should be free of lubricant which is decomposed to be non-lubricating at the high application temperature.

It is also advantageous to preheat the compressed air to at least 150° C., preferably to 170 to 275° C., but a maximum of 300° C. As a result, deposits can be prevented which otherwise form on the active surface through shock cooling and the chemical reactions of the gas components taking place at the same time.

In a particularly preferred embodiment, the compressed air is preheated in a heat exchanger by the exhaust gases. Depending on the exhaust gas temperature, the heat exchanger is arranged before or after the oxidation catalyst, but in any case before the gas conditioning stage. If the exhaust gas temperature is over 350° C., the heat exchange is preferably carried out before the catalyst, if it is below 330° C., the heat exchange is preferably carried out after of catalytic oxidation.

The flow rate of the exhaust gas upstream of the oxidation catalyst is expediently in the range from 2.5 to 4.5 m/s, within the catalyst from 4 to 9 m/s. For flow rates near the upper limits, a hardened surface is recommended at the inlet, e.g. over a length of 40 mm. Otherwise the mentioned speed ranges lead to operation which is only slightly abrasive.

To avoid condensation of water and the resulting permanent deposits, a bypass of the catalyst is helpful at the start of operation. The volume flow is typically less than 20% of the normal operating volume flow here. It is further preferred to heat the oxidation catalyst to >140° C. during standstill times. This can preferably be carried out by means of an air circulation heating system for standstill times.

It is particularly preferred to arrange the gas conditioning and catalytic oxidation in a common housing. The combined device is dimensioned as a function of the required gas flow volume and the conditions. Practical diameters of 4 to 9 m allow gas phase currents of up to 400,000 m³/h (standard condition).

The combined gas conditioning and catalytic oxidation preferably comprises the following components in the flow direction of the gas:

a gas inlet region, preferably with a compensating distributor
if necessary, the rotating unit for compressed air cleaning of the catalyst
the catalyst
a gas conditioning section.
A heat exchanger for preheating the compressed air is optionally arranged before the rotating unit or after the catalyst for compressed air cleaning. A dust removal device can be provided at the gas outlet.

The catalyst generally consists of individual cartridges in which the catalyst elements are combined. Expediently, the cartridges have the form of equilateral triangles having cartridge side lengths adapted to the radius of the housing. The individual catalyst elements ideally also have shapes with an equilateral triangular base surface. As a result and through the use of catalyst cartridges arranged in a circle, dust deposit surfaces are minimised. The typical dimensions of the individual catalyst elements are 150 mm side edge length and 500 to 1300 mm element length. These individual catalyst elements can thus be produced with conventional catalyst production matrices. The catalyst cartridges accommodating the individual elements allow variable side lengths, for example 1450 mm. Such a measurement enables a cartridge consisting of 81 individual elements with a catalyst volume per cartridge of 1.2 m³.

Gas conditioning is usually carried out by supplying conditioning water, which is generally injected into the exhaust gas into a so-called evaporative cooler. In this conventional method step, the gas humidity and temperature are adjusted. The preferred gas purification is carried out by adding slurried calcium hydroxide. The dispersion of the absorption solution into the gas to be purified is advantageously achieved by means of a dual-substance nozzle supplied with compressed air. The absorption solution is added mixed together with the normal and cooling conditioning water, which also means that the cooling water balance is not changed and the necessary gas humidity and temperature are also adequately adjusted.

The heat exchanger for preheating the compressed air for cleaning the catalyst is present in the gas flow before or after the catalyst level. Here, the initially cold compressed air is guided through tubes arranged in a serpentine manner and thus increases in temperature. The dust deposited on the tubes is removed at periodic intervals by means of knocking or vibration. The coiled tube is made to vibrate for dust removal. The amplitude is only a few millimetres. This amplitude is nevertheless sufficient to mobilise the necessary shearing forces which exceed the cohesive and adhesive forces of the dust cake and then remove this in the gas direction as a result. In order to ensure natural resonance and the associated vibration of the tubes, a minimum coiled tube length must not be fallen below. Furthermore, the coiled tubes are to be suspended freely. The non-damping coiled tube single path length is usually between 4 and 12m, depending on the arrangement. The tubes used typically have a diameter of 75 to 150 mm for a wall thickness of 4 to 8 mm.

According to the invention, a particular preliminary dust removal is preferably not carried out and the dust concentration according to the preheat exchanger cyclones can also be 100 g/m³ (standard condition) within the normal framework. Known dust separation devices, for example bag filters, are used for the final dust removal of the purified and conditioned exhaust gases after the reactor and the mill. Electrical dust separation devices can also be used.

The invention will be illustrated further with reference to the accompanying figures, without restricting the scope to the specific embodiments described. The invention further includes all combinations of described and especially of preferred featurest that do not exclude each other.

The words “about” or “approx.” in combination with a numerical figure mean that values that are higher or lower by 10% or values that are higher or lower by 5% and in any case values that are higher or lower by 1% are included. If not otherwise specified any amount in % is by weight and in the case of doubt referring to the total weight of the mixture.

Here are shown:

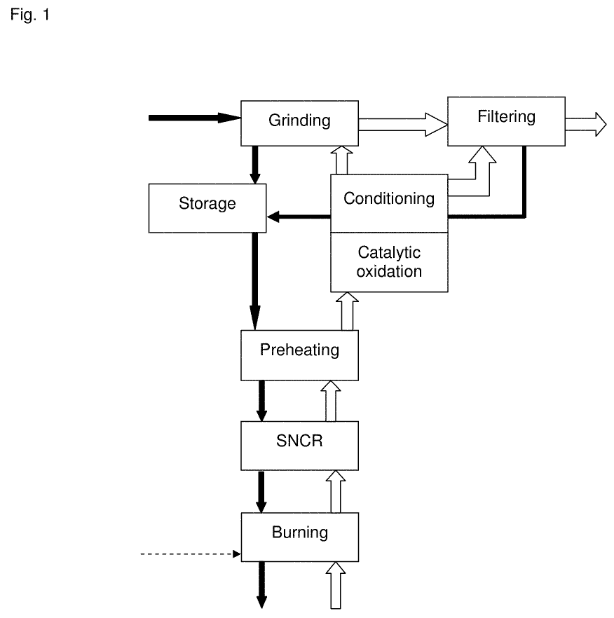

FIG. 1 a schematic overview of the method according to the invention

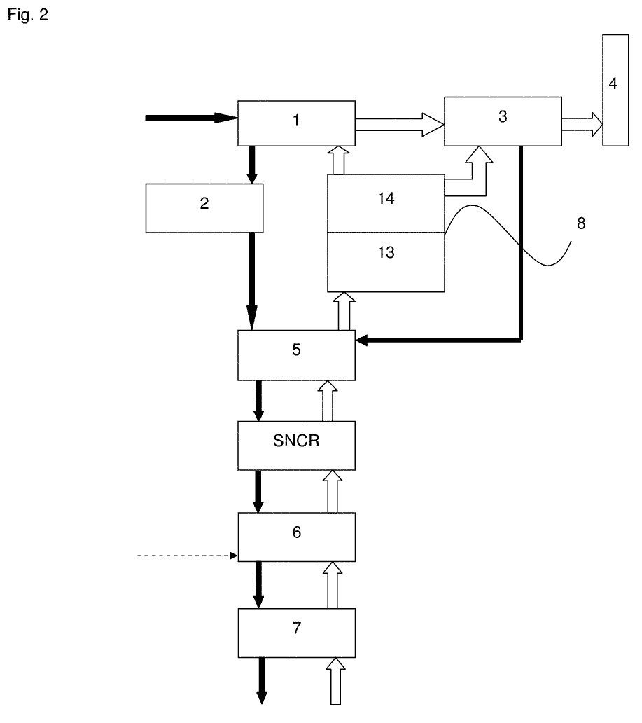

FIG. 2 a schematic depiction of a plant for cement production

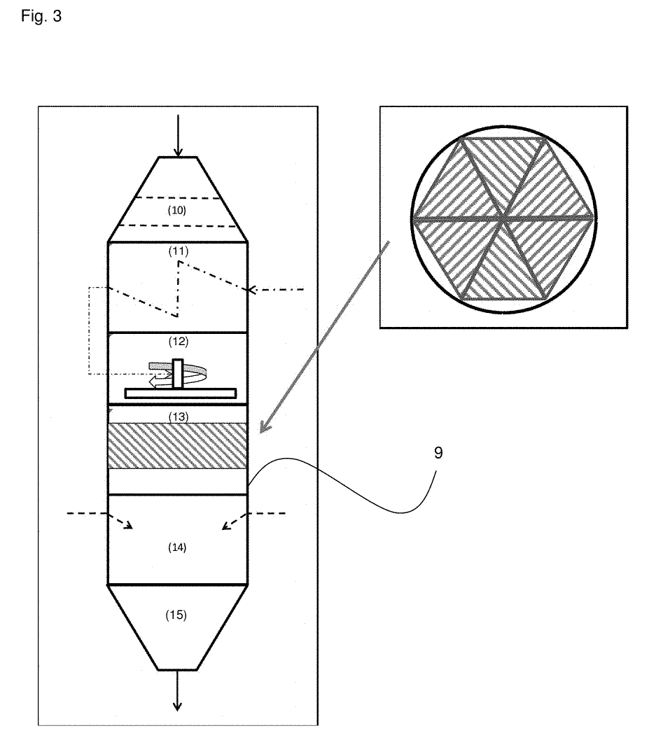

FIG. 3 a device according to the invention for gas conditioning and catalytic oxidation.

FIG. 1 illustrates the method steps. The solid material flows are shown by solid arrows, the gas flows with outlined arrows. Raw materials are ground in a mill in a known manner. The raw meal produced is supplied to preheating, wherein storage in a raw meal silo is generally interposed. Preheating may include precalcination. The preheated and optionally precalcined raw meal is supplied to the rotary kiln, where it is burned to form cement clinker. The subsequent steps of cooling, grinding etc. are not shown. Fuel is supplied (dashed arrow) and burned to burn the raw meal in the kiln. Nitrogen oxides are produced both here and in the entire hot region of the kiln from oxygen and nitrogen. In the kiln, air flows in countercurrent to the raw meal such that the hot exhaust gas containing nitrogen oxides and other pollutants leaves the kiln at the point at which the raw meal is fed. From there, it is guided towards preheating, where the reagent for the SNCR is admixed according to the invention. In the preheating process, the denitrified exhaust gas heats the raw meal and is then guided into gas conditioning and catalytic oxidation. There, ammonia is oxidised to form nitrogen and, if applicable, further pollutants are oxidised and/or removed by gas purification. The denitrified exhaust gas, which is largely freed of ammonia, is guided either into the mill or into the exhaust gas filter which is arranged behind the mill.

FIG. 2 shows a typical plant for cement production. Raw materials are supplied to a mill 1 where they are ground to form raw meal. The raw meal reaches a silo 2, the exhaust gas from the mill a filter 3. Dust deposited in the filter 3 is supplied to the raw meal or for another use. The exhaust gas purified in the filter 3 is discharged through a stack 4. The raw meal is guided from the silo 2 into a preheater 5. The preheater is typically formed of a 4- to 6-stage cyclone heat exchanger. In the preheater 5, the raw meal is heated by hot exhaust gas from the rotary kiln 6 and the exhaust gas is cooled. In some plants, precalcination takes place in addition to preheating, usually with the addition of additional energy. The raw meal, which is preheated in this way and optionally precalcined, is supplied to the rotary kiln 6 and is gradually heated there such that it is sintered to form cement clinker. The cement clinker is already partially cooled in the kiln outlet, but in any case in the clinker cooler 7 by the supply of air. The air heated as a result is used as combustion air in the kiln 6 and leaves this as exhaust gas at the point at which the raw meal is supplied. According to the invention, a reagent which provides ammonia for the non-catalytic reduction of nitrogen oxides is supplied to the exhaust gas before entering the preheater 5. The denitrified exhaust gas is supplied to the preheater 5 and heats the raw meal. According to the invention, it is guided from the preheater 5 into a device 8 for gas conditioning and catalytic oxidation. The device 8 can be formed as two separate devices; it is preferably a unitary device. The exhaust gas is firstly brought into contact with an oxidation catalyst in the device 8. Gas conditioning then takes place, in which at least an adjustment of temperature and humidity of the exhaust gas, preferably also a gas purification, takes place. The exhaust gas is preferably purified with an aqueous solution of an alkaline substance, in particular calcium hydroxide. If fuels and raw materials contain little sulphur, gas conditioning without alkaline substances is completely sufficient. The exhaust gas is now denitrified and contains little to no ammonia. In this way, it can be supplied to the filter 3 without problems in direct operation. In normal operation, it is fed into the mill 1.

FIG. 3 shows the structure of the preferred device 8 for gas conditioning and catalytic oxidation and a sectional enlargement of the oxidation catalyst. The device 8 is accommodated in a housing 9. At its inlet end, a compensating distributor 10 is provided which ensures homogeneous gas and dust inflow. The exhaust gas then passes through a heat exchanger 11 in which it emits part of its heat to the compressed air for cleaning the catalyst, said compressed air being preheated as a result. The preheated compressed air is supplied to a rotating unit 12 which blows the inflow surfaces of the subsequent oxidation catalyst 13 clear from time to time. As can be seen in the sectional enlargement, the oxidation catalyst 13 is held in cartridges, the cross section of which corresponds to an equilateral triangle having a side length which is adapted to the radius of the housing 9. Gas conditioning 14 follows the oxidation catalyst 13. Depending on the sulphur content in the raw materials and fuels, an alkaline substance is additionally contained in the water is injected for gas conditioning for gas purification. Here, dust removal 15 is also arranged subsequent to the gas conditioning 14.

The exhaust gas leaving the housing 9 is largely freed of pollutants. The nitrogen oxides were removed in the SNCR, ammonia and optionally sulphur oxides were converted to nitrogen and CaSO_{3/4} or removed in the SCO and gas conditioning. Other oxidisable pollutants such as, for example, mercury were transferred into a form which is more easily separable in the filter 3 or converted into harmless substances by oxidation.

1-18. (canceled)

19. A method for the purification of exhaust gas from the production of cement clinker in a rotary kiln, comprising the following steps:
grinding raw materials in a mill to form raw meal,
preheating the raw meal in countercurrent in a preheater with exhaust gas from the rotary kiln and optionally precalcinating the raw meal,
supplying the preheated and optionally precalcined raw meal to the rotary kiln and burning the raw meal in the rotary kiln to form cement clinker,
denitrifying the exhaust gas from the rotary kiln before entering the preheater by a selective non-catalytic reduction with a reagent which provides ammonia, wherein the molar ratio of ammonia to nitrogen oxides in the non-catalytic reduction is adjusted to 1.1 to 2.5, and
subjecting the exhaust gas from the preheater to catalytic oxidation and gas conditioning.

20. The method according to claim 19, wherein a gas purification with alkaline substances, preferably calcium hydroxide, is carried out as gas conditioning.

21. The method according to claim 19, wherein aqueous ammonia or urea solution is used as the reagent.

22. The method according to claim 19, wherein the addition of reagent is measured in such a way that the nitrogen oxide concentration in the exhaust gas after the non-catalytic reduction is below 450 mg/m³, preferably below 200 mg/m³, in particular below 150 mg/m³.

23. The method according to claim 19, wherein the molar ratio of ammonia to nitrogen oxides in the non-catalytic reduction is adjusted to 1.3 to 1.6.

24. The method according to claim 19, wherein the addition of reagent takes place at a point at which the exhaust gases have a temperature of 800 to 1000° C., preferably from 830 to 950° C.

25. The method according to claim 19, wherein the cross section and type of oxidation catalyst and the flow rate of the exhaust gas through the catalyst are selected in such a way that the ammonia concentration in the exhaust gas after catalytic oxidation is below 30 mg/m³, preferably below 10 mg/m³.

26. The method according to claim 19, wherein the oxidation catalyst is blown clear from time to time, typically every 0.2 to 2 hours, by means of compressed air from a rotating unit.

27. The method according to claim 26, wherein the rotating unit is driven by the compressed air.

28. The method according to claim 26, wherein the compressed air is preheated, preferably to 150 to 300° C., in particular to 170 to 240° C.

29. A device for catalytic oxidation and gas conditioning in a plant for the production of cement clinker, comprising:
a mill, in which raw materials are ground to form raw meal,
a preheater, in which the raw meal is preheated in countercurrent with exhaust gas from a rotary kiln and optionally precalcined, the rotary kiln, in which the preheated and optionally precalcined raw meal is burned to form cement clinker, and
a section between the rotary kiln and preheater, in which nitrogen oxides are reduced with a reagent which provides ammonia, said section being arranged between the mill and preheater, wherein the oxidation catalyst contains titanium dioxide with 1 to 4% by weight vanadium pentoxide and/or tungsten trioxide and the molar ratio of ammonia to nitrogen oxides in the non-catalytic reduction is adjusted to 1.1 to 2.5.

30. The device according to claim 29, wherein catalytic oxidation and gas conditioning are arranged in one housing.

31. The device according to claim 29, wherein the oxidation catalyst is doped with one or more of precious metals, copper and magnesium.

32. The device according to claim 29, wherein the oxidation catalyst consists of elements which are held in cartridges, the cross sections of which being equilateral triangles, wherein the side length of the cartridges is adapted to the radius of the housing.

33. The device according to claim 29, wherein a compensating distributor is arranged on the gas inlet into the housing.

34. The device according to claim 29, wherein a dust removal device is arranged before the gas outlet from the housing.

35. The device according to claim 29, wherein a rotating unit with offset nozzles varying in cross section is present to introduce compressed air, by means of which the catalyst can be blown clear by compressed air.

36. The device according to claim 35, wherein a heat exchanger is provided, by means of which the compressed air is preheated, preferably by the exhaust gas.
